(19) United States
(12) Patent Application Publication
(10) Pub. No.: US 2004/0137332 A1
(43) Pub. Date: Jul. 15, 2004

(54) Electrolyte for rechargeable lithium battery and rechargeable lithium battery comprising same

(76) Inventors: Hyeong-Gon Noh, Suwon-city (KR); Eui-Hwan Song, Suwon-city (KR)

Correspondence Address: CHRISTIE, PARKER & HALE, LLP, P.O. BOX 7068, PASADENA, CA, 91109-7068, US

(21) Appl. No.: 10/743,638

(22) Filed: Dec. 22, 2003

(30) Foreign Application Priority Data
Dec. 27, 2002 (KR) 2002-0084987

(51) Int. Cl. H01M 10/40; H01M 4/58

(52) U.S. Cl. 429/329; 429/231.8

(57) ABSTRACT

Disclosed is an electrolyte including a non-aqueous organic solvent, a lithium salt and an additive represented by formula 1:

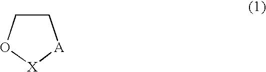

where X is a functional group with Y, where Y is an element belonging to Groups 3, 4, 5, or 6 of the Periodic Table; and A is O or NR, where R is a C₁ to C₆ alkyl group; wherein, if X is CO, A is NR. Batteries using such a solvent in the electrolyte are less susceptible to swelling without any decrease in capacity or cycle life characteristics.

### CROSS REFERENCE TO RELATED APPLICATION

This application claims priority on Korean patent application No. 2002-84987 filed in the Korean Intellectual Property Office on Dec. 27, 2002, the entire disclosure of which is incorporated hereinto by reference.

### FIELD OF THE INVENTION

The present invention relates to an electrolyte for a rechargeable lithium battery and a rechargeable lithium battery comprising the same and more particularly, to an electrolyte for a rechargeable lithium battery exhibiting high capacity and good cycle life characteristics, and being capable of suppressing high-temperature swelling, and a rechargeable lithium battery comprising the same.

### BACKGROUND OF THE INVENTION

Recently, the rapid development of smaller, lighter, and higher performance communication and other electronic equipment has required the development of high performance and large capacity batteries to power such equipment. The demands for large capacity batteries have fostered investigation of rechargeable lithium batteries. Positive active materials for rechargeable lithium batteries use lithium-transition metal oxides, and negative active materials use crystalline carbon, amorphous carbon or carbon composites. The active materials are coated on a current collector with a predetermined thickness and length or they are formed as a film to produce electrodes. The electrodes together with a separator are wound to produce an electrode element and the electrode element is inserted into a battery case such as a can followed by insertion of an electrolyte to fabricate a battery.

The rechargeable lithium battery theoretically exhibits an average discharge voltage of about 3.6 to 3.7V, which is higher than other alkaline batteries such as Ni-MH (M is hydrogen storage metal) batteries or Ni—Cd batteries. However, such a high discharge voltage can only be obtained from an electrolyte which is electrochemically stable at charge and discharge voltage, 0 to 4.2V. The electrochemically stable electrolyte includes non-aqueous mixed carbonates such as ethylene carbonate, dimethyl carbonate, or diethyl carbonate.

During initial charging, lithium ions from a lithium-transition metal oxide positive electrode transfers to a carbonaceous negative electrode to cause the intercalation of lithium ions to the carbonaceous negative electrode. At this time, highly reactive lithium reacts with the carbonaceous negative electrode to generate Li₂CO₃, LiO or LiOH, thereby forming a thin film on a surface of the negative electrode. Such a thin film is called a solid electrolyte interface (SEI) film. The SEI film not only prevents side reactions between lithium ions and a carbonaceous negative electrode or other material during charging and discharging, but also acts as an ion tunnel, allowing the passage of only lithium ions. The ion tunnel prevents the disintegration of the structure of the carbonaceous negative electrode because organic solvents in an electrolyte with a high molecular weight solvate lithium ions, and the solvent and the solvated lithium ions are co-intercalated into the carbonaceous negative electrode. Once the SEI film is formed side reactions do not occur, and therefore, the amount of lithium ions is maintained. That is, the carbonaceous negative electrode reacts with an electrolyte during the initial charging to form a passivation layer such as an SEI film on the surface of the negative electrode, thereby preventing the decomposition of the electrolyte and allowing stable charging and discharging (J. Power Sources, 51(1994), 79-104). According to the mechanism, an irreversible formation reaction of the passivation layer occurs during the initial charging and discharging and does not occur thereafter, thereby exhibiting stable cycle life characteristics.

However, a thin prismatic battery has a problem in which a carbonate-based organic solvent of the electrolyte is decomposed to generate gases in the battery (J. Power Sources, 72(1998), 66-70). These gases include H₂, CO, CO₂, CH₄, CH₂, C₂H₆, C₃H₈, C₃H₆, etc. depending on the type of non-aqueous organic solvent and negative active material used. Such generated gas causes expansion of the volume of the battery and an increase in electrochemical energy and heat energy when the battery is stored at high temperatures, thereby slowly disintegrating the passivation layer which results in a side reaction between the exposed surfaces of the negative electrode. Such gas-generation causes an increase in internal pressure, which induces the deformation of the prismatic battery and lithium polymer battery, thereby deteriorating battery performances and stability.

One attempt to solve these problems has been to add an additive to an electrolyte. As additives, carbonate-based compounds are disclosed in U.S. Pat. No. 5,626,981 and Japanese Patent Laid-Open No. 2002-15769. However, there are various problems with these methods: the added compound is decomposed or forms an unstable film by interacting with the carbon negative electrode during initial charging and discharging according to inherent electrochemical characteristics, resulting in the deterioration of the ion mobility in an electron; and gas is generated inside the battery such that there is an increase in internal pressure, resulting in the significant worsening of the storage characteristics, stability, cycle life, and capacity of the battery.

In addition, Korean Patent Laid-Open No. 2001-86281 discloses adding a sulfone-based organic compound to an electrolyte. The sulfone-based organic compound can effectively suppress swelling, but causes a decrease in capacity and deterioration of the cycle life characteristic. Thus, the use of sulfone-based organic compounds is useful for prismatic batteries in which the swelling problem is more critical rather than the capacity and the cycle life characteristics, but it is not useful for pouch-type batteries.

### SUMMARY OF THE INVENTION

It is an aspect of the present invention to provide an electrolyte for a rechargeable lithium battery which is applicable to all types of batteries such as prismatic or pouch batteries, and is capable of suppressing swelling without any decrease in capacity or cycle life characteristics.

It is another aspect to provide a rechargeable lithium battery including the same.

These and other aspects may be achieved by an electrolyte for a rechargeable lithium battery including a non-aqueous organic solvent; a lithium salt; and an additive represented by formula 1:

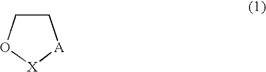

where X is a functional group with Y, where Y is an element belonging to Groups 3, 4, 5, or 6 of the Periodic Table; and

A is O or NR, where R is a C₁-C₆ alkyl group;

but if X is CO, A is NR.

In order to achieve these aspects and others, the present invention provides a rechargeable lithium battery including the electrolyte; a positive electrode; and a negative electrode. The positive electrode and the negative electrode include active materials that are capable of intercalating and deintercalating lithium.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a graph illustrating the discharge characteristics of the cells according to Example 1 of the present invention and Comparative Example 1;

FIG. 2 is a graph illustrating the cycle life characteristics of the cells according to Example 1 of the present invention and Comparative Example 1; and

FIG. 3 shows an embodiment of the rechargeable lithium battery of the present invention.

### DETAILED DESCRIPTION OF THE INVENTION

The present invention relates to an electrolyte for a rechargeable lithium battery exhibiting high capacity and good cycle life characteristics, and that can effectively suppress swelling.

The electrolyte of the present invention includes an additive represented by formula 1. The additive is added to a conventional electrolyte which includes a non-aqueous organic solvent and a lithium salt:

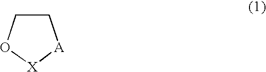

where X is a functional group that includes Y, where Y is an element selected from Groups 3, 4, 5, or 6 of the Periodic Table; and

A is O or NR, where R is a C₁-C₆ alkyl group;

but if X is CO, A is NR.

Y is preferably selected from the group consisting of B, C, Si, N, P, and S. Preferably, X is selected from the group consisting of SO₂, CO, PO, and SO. Most preferred is a thiolane-based compound represented by formula 1a. In the thiolane-based compound, an “O═S═O” site acts to suppress the high-temperature swelling, and and “O—S—O” or “O—S—NCH₃” site acts to maintain capacity and cycle life characteristics.

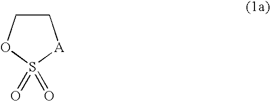

where A is O or NR, where R is a C₁ to C₆ alkyl group.

The additive is preferably present in the amount of 0.01 to 10 wt %, and more preferably 1 to 8 wt % of the weight of the non-aqueous organic solvent in the electrolyte of the present invention. If the amount of the additive is less than 0.01 wt %, the effect by addition of the additive cannot be achieved. If the amount of the additive is more than 10 wt %, it is not economical and it may generate gases during a formation step.

The non-aqueous organic solvent includes at least one cyclic carbonate, linear carbonate, ester, ether, or ketone. If a mixture thereof is used, the mixing ratio can be suitably controlled according to the desired battery performances, as is well understood in the related art. Preferred cyclic carbonates include ethylene carbonate, propylene carbonate, and mixtures thereof. Preferred linear carbonates include dimethyl carbonate, diethyl carbonate, ethylmethyl carbonate, methyl propyl carbonate and mixtures thereof. Preferred esters include γ-butyrolactone, valerolactone, decanolide, mevalolactone and mixtures thereof. Preferred ketones include polymethylvinyl ketone.

The non-aqueous organic solvent may further be a halogenated benzene in order to improve low-temperature, cycle life, and high-temperature characteristics. The halogenated benzene is represented by formula 2:

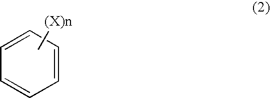

where X is F, Cl, Br or I, and n is an integer from 1 to 3.

The halogenated benzene has a high freezing point and is stable at working voltages of the battery. In addition, the halogenated benzene exhibits high conductivity at low temperatures.

The amount of the halogenated benzene is 1 to 20 parts by volume based on 100 parts by volume of the total electrolyte. If the amount of the halogenated benzene is less than 1 part by volume, ionic conductivity at low temperatures decreases. If the amount of the halogenated benzene is more than 20 parts by volume, ionic conductivity at room temperatures decreases.

The electrolyte includes a lithium salt as a supporting electrolytic salt. Preferred lithium salts include lithium hexafluorophosphate (LiPF₆), lithium tetrafluoroborate (LiBF₄), lithium perchlorate (LiCIO₄), lithium trifluoromethanesulfonate (CF₃SO₃Li), lithium hexafluoroarsenate (LiAsF₆) and mixtures thereof. The lithium salt acts as a source of lithium ions in the battery, and helps the battery operation. In addition, the lithium salt activates transfer of lithium ions between a positive electrode and a negative electrode.

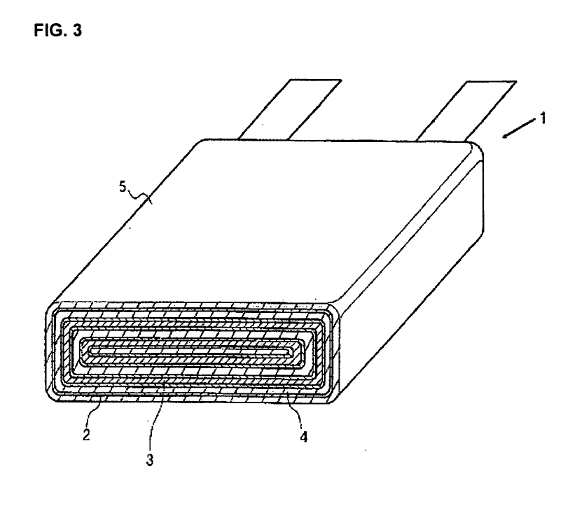

An embodiment of the rechargeable lithium battery of the present invention is shown in FIG. 3. The rechargeable lithium battery 1 in FIG. 3 includes a positive electrode 3, a negative electrode 4, and an electrolyte 2. The positive electrode 3, the negative electrode 4, and the electrolyte 2 are received in a battery case 5.

The positive electrode includes a positive active material in which lithium intercalation reversibly occurs. Examples of the positive active material are lithium transition metal oxides such as LiCoO₂, LiNiO₂, LiMnO₂, LiMn₂O₄, or LiNi_{1-x-y}CoₓM_{y}O₂ where x is from 0 to 1, y is from 0 to 1 and x+y is from 0 to 1, and M is a metal such as Al, Sr, Mg, or La.

The negative electrode includes a negative active material in which lithium intercalation reversibly occurs. Examples negative active materials are crystalline or amorphous carbonaceous materials, and carbon composites.

The positive active material and the negative active material are respectively coated on current collectors to produce electrodes, and the electrodes are wound together with or laminated on a separator to produce an electrode element. The electrode element is inserted into a battery case such as a can, and an electrolyte is injected into the case to fabricate a rechargeable lithium battery. The separator may be a resin such as polyethylene or polypropylene.

The following Examples further illustrate the present invention in detail, but are not to be construed to limit the scope thereof.

### EXAMPLE 1

94 wt % of a LiCoO₂ active material, 3 wt % of a Super-P conductive agent, and 3 wt % of a polyvinylidene fluoride binder were mixed in an N-methyl pyrrolidone solvent to prepare a positive active material slurry.

The positive active material slurry was coated on an Al-foil current collector and dried to produce a positive electrode with a width of 4.9 cm and a thickness of 147 μm.

89.8 wt % of an artificial graphite negative active material (PHS, available from Japan Carbon Ltd.), 0.2 wt % of an oxalic acid additive, and 10 wt % of a polyvinylidene fluoride binder were mixed in a N-methyl pyrrolidone solvent to prepare a negative active material slurry. The negative active material slurry was coated on a Cu-foil current collector and dried to produce a negative electrode with a width of 5.1 cm and a thickness of 178 μm.

Using the positive electrode, the negative electrode, a polyethylene film separator available from Asahi, Co. Ltd., having a width of 5.35 cm, and a thickness of: 18 μm, and an electrolyte, a rechargeable lithium cell with a nominal capacity of 640 mAh was fabricated.

The electrolyte was produced by dissolving 1.15M LiPF₆ in a mixed solvent of ethylene carbonate, ethyl methyl carbonate, propylene carbonate and fluorobenzene at a volume ratio of 30:55:10:5, and adding 1,3,2-dioxathiolane 2,2-dioxide represented by formula 1a thereto. At this time, the amount of 1,3,2-dioxathiolane 2,2-dioxide was 3 wt % of the weight of the mixed solvent.

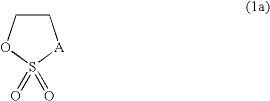

### COMPARATIVE EXAMPLE 1

A rechargeable lithium cell was fabricated by the same procedure as in Example 1, except that the 1,3,2-dioxathiolane 2,2-dioxide represented by formula 1a was not used.

### COMPARATIVE EXAMPLE 2

A rechargeable lithium cell was fabricated by the same procedure as in Example 1, except that vinyl sulfone was used instead of 1,3,2-dioxathiolane 2,2-dioxide represented by formula 1a in the amount of 0.5 wt % of the weight of the mixed solvent.

The rechargeable lithium cells according to Example 1 and Comparative Examples 1 and 2 were charged at 0.1C, 0.5C, 1C, and 2C, respectively. The IR2 value, standard charge capacity and standard discharge capacity were measured. In addition, discharge capacities at various C-rates, i.e. 0.5C, 1C, and 2C, and capacity retention were measured. The results are shown in Table 1. The IR2 value was obtained from full-charging at 4.2V after formation. The standard charge capacity and the standard discharge capacity were obtained from charging at 0.5C and discharging at 0.2C after formation. The standard efficiency was a percentage value obtained from the standard discharge capacity to the standard discharge capacity. The discharge capacity at various C-rates, were obtained from discharging for 2 hours (0.5C), 1 hour (1C), and 30 minutes (2C), respectively. As the C-rate increases, the discharge capacity decreases. The capacity retention was a percentage value obtained from the measured discharge capacity to the standard discharge capacity.

TABLE 1

| | | Standard | Standard | Standard | 0.5C | | 1C | | 2C | |
|---|---|---|---|---|---|---|---|---|---|---|
| | 1R2 | Charge | discharge | Efficiency | Discharge | Capacity | Discharge | Capacity | Discharge | Capacity |
| | (mΩ) | (mAh/g) | (mAh/g) | (%) | (mAh/g) | retention % | (mAh/g) | retention % | (mAh/g) | retention % |
| Example 1 | 42.30 | 672 | 672 | 100 | 662 | 98 | 652 | 97 | 637 | 95 |
| | 42.60 | 672 | 672 | 100 | 662 | 99 | 651 | 97 | 638 | 95 |
| | 42.45 | 672 | 672 | 100 | 662 | 98 | 652 | 97 | 637 | 95 |
| Comparative | 43.10 | 646 | 638 | 99 | 633 | 99 | 628 | 98 | 612 | 96 |
| Example 1 | 42.90 | 649 | 641 | 99 | 636 | 99 | 631 | 98 | 614 | 96 |
| | 43.00 | 648 | 639 | 99 | 634 | 99 | 629 | 98 | 613 | 96 |
| Comparative | 43.70 | 610 | 574 | 94 | 547 | 95 | 531 | 92 | 538 | 94 |
| Example 2 | 43.20 | 611 | 574 | 94 | 545 | 95 | 530 | 92 | 537 | 93 |
| | 43.45 | 610 | 574 | 94 | 546 | 95 | 531 | 92 | 537 | 94 |

As shown in Table 1, the cell according to Example 1 exhibited slightly higher charge and discharge capacities and excellent efficiency compared to Comparative Examples 1 and 2. In addition, the cell according to Example 1 exhibited higher discharge capacities at 0.5C, 1C, and 2C compared to Comparative Examples 1 and 2.

The rechargeable lithium cells according to Example 1 and Comparative Examples 1 and 2 were allowed to stand at 90° C. for 4 hours. From the initial thickness 20 of the cells, and the final thickness after 4 hours, the swelling properties (increases in the thickness) were determined. The results are presented in Table 2.

TABLE 2

| | Initial thickness | Final thickness | Increases in the |
|---|---|---|---|
| | (μm) | (μm) | thickness (%) |
| Comparative | 4.15 | 5.25 | 23 |
| Example 1 | | | |
| Comparative | 4.15 | 4.51 | 9 |
| Example 2 | | | |
| Example 1 | 4.15 | 4.55 | 10 |

It is evident from Table 2 that the increase in the thickness of the cell according to Example 1 was reduced compared to that of the cells according to Comparative Example 1. This result indicates that swelling was effectively suppressed in the cell according to Example 1 compared to that according to Comparative Example 1, and it corresponded to that according to Comparative Example 2.

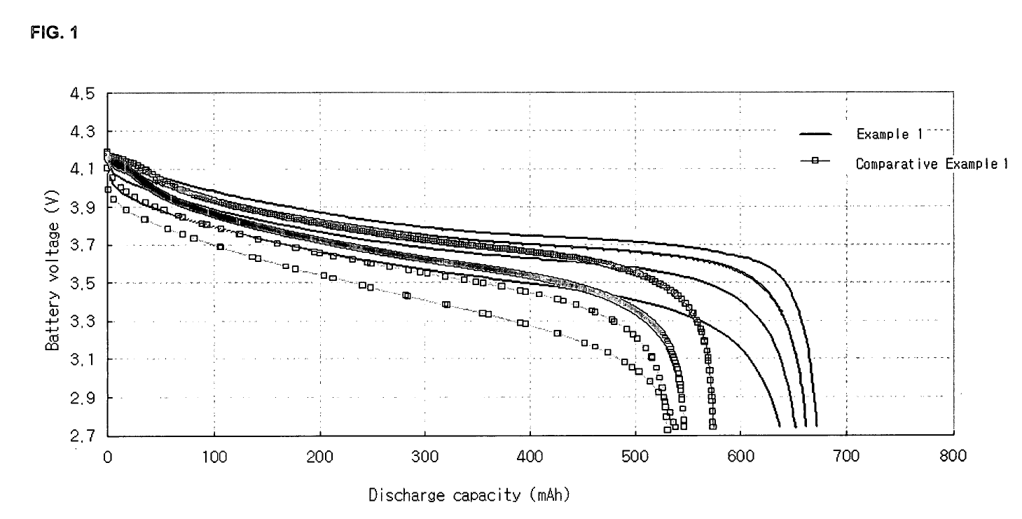

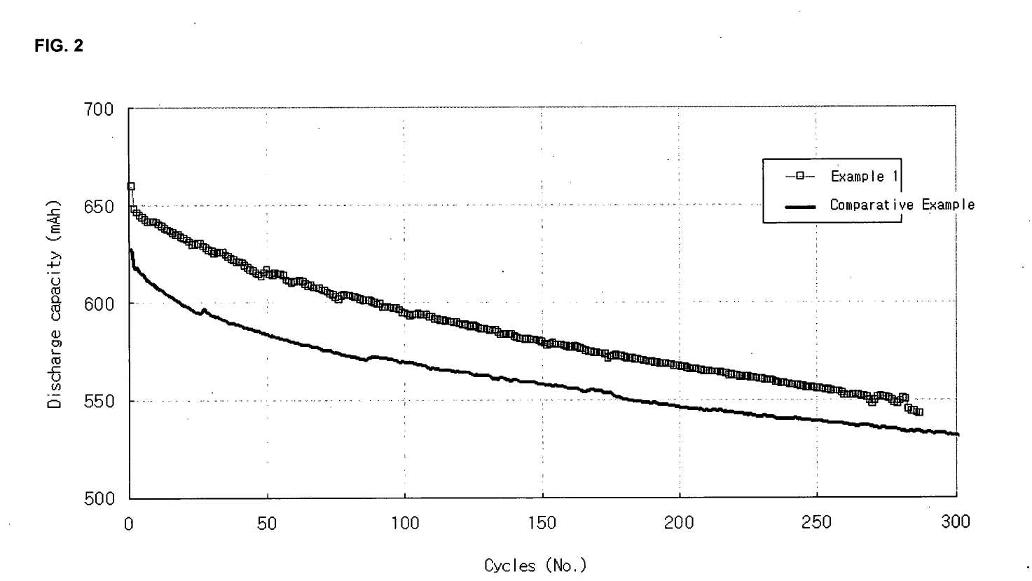

The discharge capacity and the cycle life characteristics of the cells according to Example 1 and Comparative Example 2 were measured by constant-current and constant-voltage charging at 0.5C to 4.2V (25° C.) and a cut-off of 20 mA, and discharging at a cut-off of 2.75V, while the C-rates were changed from 0.2C, 0.5C, 1C, and 2C. The results are presented in FIGS. 1 and 2, respectively. The results from FIGS. 1 and 2 indicated that the cell according to Example 1 exhibited higher discharge capacity and better cycle life characteristics the cell of Comparative Example 1.

It is evident from Tables 1 and 2 and FIGS. 1 and 2 that the cell according to Example 1 with a thiolane-based compound exhibits the corresponding effects of better suppression of swelling at high temperatures and higher discharge capacity and better cycle life characteristics compared to Comparative Example 2 with vinyl sulfone. It is expected from these results that the thiolane-based compound is useful in pouch batteries.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. An electrolyte for a rechargeable lithium battery comprising:
a non-aqueous organic solvent;
a lithium salt; and
an additive represented by formula 1: 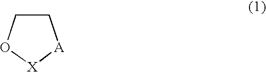
where X is a functional group that includes Y, where Y is an element selected from Groups 3, 4, 5, and 6 of the Periodic Table; and
A is O or NR, where R is a C₁ to C₆ alkyl group;
wherein if X is CO, A is NR.)

2. The electrolyte of claim 1, wherein Y is selected from the group consisting of B, C, Si, N, P, and S.

3. The electrolyte of claim 1, wherein X is selected from the group consisting of SO₂, CO, SO, and PO.

4. The electrolyte of claim 1, wherein the additive is provided in an amount between 0.01 and 10 wt % of the weight of the non-aqueous organic solvent.

5. The electrolyte of claim 1, wherein the non-aqueous organic solvent is selected from the group consisting of cyclic carbonates, linear carbonates, esters, ethers, ketones and mixtures thereof.

6. The electrolyte of claim 5, wherein the non-aqueous organic solvent further comprises a halogenated benzene represented by formula 2. 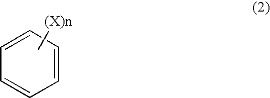
where X is F, Cl, Br or I, and n is an integer from 1 to 3.

7. The electrolyte of claim 6, wherein the halogenated benzene is provided in an amount between 1 and 20 parts by weight based on 100 parts by weight of the electrolyte.

8. The electrolyte of claim 1, wherein the lithium salt is selected from the group consisting of lithium hexafluorophosphate (LiPF₆), lithium tetrafluoroborate (LiBF₄), lithium perchlorate (LiCIO₄), lithium trifluoromethanesulfonate (CF₃SO₃Li), lithium hexafluoroarsenate (LiAsF₆) and mixtures thereof.

9. A rechargeable lithium battery comprising:
an electrolyte comprising a non-aqueous organic solvent, a lithium salt and an additive represented by formula 1:
a positive electrode comprising a positive active material which is capable of intercalating and deintercalating lithium; and
a negative electrode comprising a negative active material which is capable of intercalating and deintercalating lithium; and 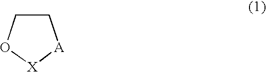
where X is a functional group that includes Y, where Y is an element belonging to Groups 3, 4, 5 or 6 of the Periodic Table; A is O or NR, where R is a C₁ to C₆ alkyl group; and if X is CO, A is NR.

10. The rechargeable lithium battery of claim 9, wherein Y is selected from the group consisting of B, C, Si, N, P, and S.

11. The rechargeable lithium battery of claim 1, wherein X is selected from the group consisting of SO₂, CO, SO, and PO.

12. The rechargeable lithium battery of claim 9, wherein the additive is provided in an amount from 0.01 to 10 wt % of the weight of the non-aqueous organic solvent.

13. The rechargeable lithium battery of claim 9, wherein the negative active material is selected from the group consisting of crystalline carbon, amorphous carbon and carbon composites.

14. The rechargeable lithium battery of claim 9, wherein the non-aqueous organic solvent is selected from the group consisting of cyclic carbonates, linear carbonates, esters, ethers, ketones and combinations thereof.

15. The rechargeable lithium battery of claim 14, wherein the non-aqueous organic solvent further comprises a halogenated benzene represented by formula 2: 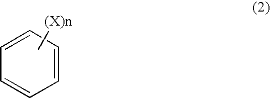
where X is F, Cl, Br or I, and n is an integer from 1 to 3.

16. The rechargeable lithium battery of claim 15, wherein the halogenated benzene is provided in an amount from 1 to 20 parts by weight based on 100 parts by weight of the electrolyte.

17. The rechargeable lithium battery of claim 9, wherein the lithium salt is selected from the group consisting of lithium hexafluorophosphate (LiPF₆), lithium tetrafluoroborate (LiBF₄), lithium perchlorate (LiCIO₄), lithium trifluoromethanesulfonate (CF₃SO₃Li), lithium hexafluoroarsenate (LiAsF₆) and combinations thereof.

18. An electrolyte for a rechargable lithium battery comprising:
a non-aqueous organic solvent;
a lithium salt; and
an additive of the form 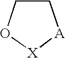
where X is selected from the group consisting of SO₂, CO, SO and PO and A is selected from the group consisting of O and NR where R is a C₁ to C₆ alkyl group, wherein, if X is CO, A is NR.
